(19) United States
(12) Patent Application Publication
(10) Pub. No.: US 2019/0094370 A1
(43) Pub. Date: Mar. 28, 2019

(54) Delivery Of Precise Time Error And/Or Compensation To GPS Receivers In An On-Board Unit Over Dedicated Short Range Communications

(71) Applicant: Panasonic Automotive Systems Company of America, Division of Panasonic Corporation of North America, Peachtree City, GA (US)

(72) Inventors: SAMEH WILLIAM TAWADROUS, SENOIA, GA (US); Hans A. Troemel, JR., Sharpsburg, GA (US)

(73) Assignee: Panasonic Automotive Systems Company of America Division of Panasonic Corporation of North America

(21) Appl. No.: 16/140,908

(22) Filed: Sep. 25, 2018

Related U.S. Application Data
(60) Provisional application No. 62/563,727, filed on Sep. 27, 2017.

(51) Int. Cl. G01S 19/07; G01S 19/31; G01S 19/35

(52) U.S. Cl. CPC G01S 19/07; G01S 19/35; G01S 19/31

(57) ABSTRACT

On-board equipment for a motor vehicle includes a DSRC radio receiving a signal from road side equipment. The signal has an accurate frequency in accordance with GPS time. A GPS receiver is communicatively coupled to the DSRC radio. The on-board equipment determines the error in the GPS receiver clock or time and provides the GPS receiver with the time error. The determining of the GPS receiver time error is dependent upon the accurate frequency in the air-borne RSE signal. The GPS time error or compensation is dependent upon the GPS accurate time.

### CROSS-REFERENCED TO RELATED APPLICATIONS

This application claims benefit of U.S. Provisional Application No. 62/563,727 filed on Sep. 27, 2017, which the disclosure of which is hereby incorporated by reference in its entirety for all purposes.

### FIELD OF THE INVENTION

The disclosure relates to an on-board unit of a dedicated short-range communication system in a motor vehicle, and, more particularly, to providing precise time to an on-board unit of a dedicated short range communication system in a motor vehicle.

### BACKGROUND OF THE INVENTION

V2X radio communications may be defined herein as a class of radio communication including dedicated short-range communications (DSRC), C-V2X radio communications, and 5G radio communications. Dedicated short-range communications (DSRC) are one-way or two-way short-range to medium-range wireless communication channels specifically designed for automotive use and a corresponding set of protocols and standards. A road side unit (RSU) is the part of a DSRC system that is installed on the side of the road. C-V2X may communicatively link motor vehicles to pedestrians, infrastructure, external communication networks, and to other vehicles. C-V2X may use a cellular network to access cloud-based services such as navigation and infotainment. RSE and OBE may be parts for the communication network (generic and not specific to DSRC).

Road Side Equipment (RSE) includes the RSU in addition to other equipment to link the RSU to a backend network that may be hosted in the cloud. An on-board unit (OBU) is the part of a DSRC system that is installed in the moving vehicle. RSU and RSE may or may not be part of the 5G network (C-V2X), 5G towers may be installed away from the road sides. Also, carriers may choose to install similar devices to the side of the road to provide coverage for this safety application.

On Board Equipment (OBE) may be the part of network that is installed in the car. On-board equipment may include other equipment in addition to the OBU, such as a human-machine interface unit and other communication equipment in the car.

After a vehicle loses track of its GPS location, the time required to re-establish the GPS location, which may be referred to as the time to first fix (TTFF), may be several minutes. This period of time may be unacceptably long for safety applications wherein the driver loses full benefit of safety features while the vehicle's OPS location is unknown.

Another problem with current GPS acquisition devices is that it is difficult to obtain a GPS fix in a weak satellite signal environment such as in an urban canyon where there is no DSRC support. Also, a long GPS TTFF may be incurred by the OBU under the same conditions. That is, there may be an inability of the GPS receiver to obtain a fix, and a long GPS TTFF may be incurred by the OBU, especially in an urban canyon environment due to weak satellite signal strength and lack of an aiding parameter provided over the communication network.

### SUMMARY

The present invention may provide precise GPS time base error or compensation to the GPS receiver in the OBE over the communication network by utilizing information obtained by the GPS receiver in the RSE or base station, in case of DSRC, the RSU as a part of the RSE is able to tune its frequency to the GPS accurate frequency after the GPS receiver in the RSE is able to get a fix. In the case of 5G, the base station is already synchronized to GPS time. Each OBU in the coverage area of the RSE or the base station may, in turn, be able to receive DSRC or 5G data and then retains its frequency to the accurate RSE or the 5G base station frequency. The OBU in car unit may also get frequency and time markers from the GPS receiver that resides in, the OBE and then calculate the difference in time between its own accurate time and that of the communication link receiver. An error message or compensation value can then be fed to the OBU GPS receiver DSP that can account for the error in the GPS search which then results in a fast TTFF.

Frequency and time may be derived from each other. Knowing frequency or time implies also knowing the other in absolute terms.

The invention may include correcting the time based clock used in the OBU GPS receiver.

In one embodiment, the invention comprises on-board equipment for a motor vehicle. The onboard equipment includes a radio receiving a signal from road side equipment or the 5G network. The signal has an accurate frequency in accordance with GPS time. A GPS receiver is communicatively coupled to the radio. The on-board equipment determines the GPS accurate time and provides the OBU GPS receiver time base error or compensation to the GPS receiver. The determining of the GPS accurate time is dependent upon the accurate frequency in the signal. The GPS time base error or compensation is dependent upon the GPS accurate time.

In another embodiment, the invention comprises a method of operating on-board equipment in a motor vehicle, including providing the on-board equipment with an on-board unit including a communication radio and a GPS receiver. The radio receives a signal from road side equipment or 5G base station. The signal has an accurate frequency in accordance with GPS time. The on-board unit establishes a frequency of the on-board unit in accordance with the signal. A GPS accurate time is determined within the on-board equipment. The GPS accurate time is dependent upon the established frequency of the on-board unit. GPS time error calculated comparing the time base of the GPS receiver and the accurate GPS. OBU GPS time base error or compensation is provided to the GPS receiver. The GPS time base error or compensation is dependent upon the GPS accurate time.

In yet another embodiment, the invention includes an arrangement for providing GPS accurate time in a motor vehicle. The arrangement includes road side equipment having a road side unit. The road side unit includes a first GPS receiver producing GPS accurate time. A first radio is communicatively coupled to the first GPS receiver. The road side unit or base station establishes a frequency of the road side unit or base station in accordance with the GPS accurate time. The road side or base station equipment transmits a signal including an accurate frequency. The accurate frequency is dependent upon the established frequency of the road side unit or base station. On-board equipment includes a second radio receiving the signal from the road side or base station equipment. A second GPS receiver is communicatively coupled to the second radio. The on-board equipment determines the GPS accurate time. The determining of the GPS accurate time is dependent upon the accurate frequency in the signal. The on-board equipment ascertains GPS receiver time base error or compensation based on the GPS accurate time. The onboard equipment provides the GPS time base error or compensation to the second GPS receiver.

An advantage of the present invention is that it may reduce the time to first fix (TTFF) a GPS location from minutes to seconds.

Another advantage is that the OBE included in coverage area of the RSE or base station may be enabled to obtain a fix at a much lower satellite signal and faster TTFF. More accurate position may be obtained by GPS receivers due to the aiding as well.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular precise time error and/or compensation arrangement of the present invention.

FIG. 2 is a block diagram of one embodiment of the road side equipment of the arrangement of FIG. 1.

FIG. 3 is a block diagram of one embodiment of the on-board equipment of the arrangement of FIG. 1.

FIG. 4 is a block diagram of another embodiment of the on-board equipment of the arrangement of FIG. 1.

FIG. 5 is a flow chart of one embodiment of a method of the present invention for operating on-board equipment in a motor vehicle.

### DETAILED DESCRIPTION OF THE PREFERRED EMBODIMENTS

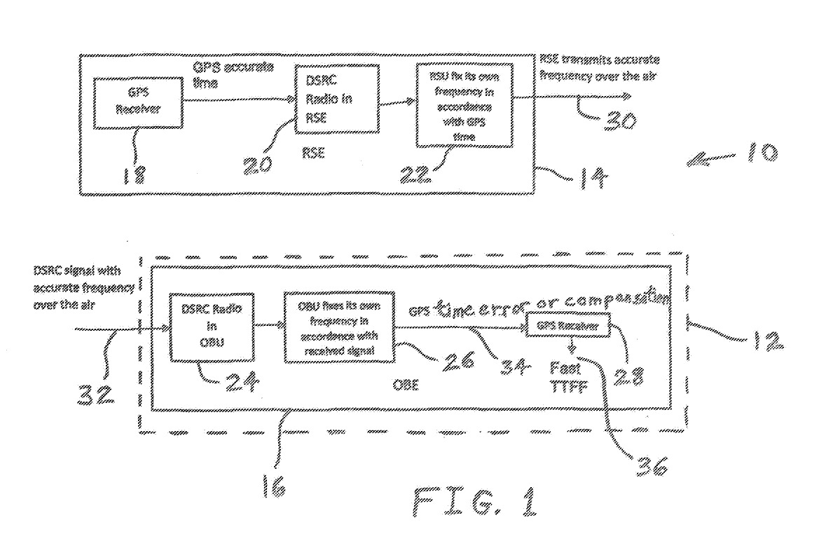

FIG. 1 illustrates one embodiment of a vehicular precise time error and/or compensation arrangement 10 of the present invention for a motor vehicle 12. Arrangement 10 includes road side equipment (RSE or base station) 14 and on-board equipment (OBE) 16 disposed within vehicle 12. RSE 14 includes a road side unit (RSU) or base station having a GPS receiver 18 and a communication radio 20 having a DSRC or 5G base station. OBE 16 includes an on-board unit (OBU) having a communication radio 24 with a DSRC or 5G unit and a GPS receiver 28.

During use, GPS receiver 18 provides GPS accurate time to radio 20. At 22, the RSU or base station may fix, modify or establish its own frequency in accordance with GPS time. The RSU or base station may then transmit its own accurate frequency signal over the air, as indicated at 30. The airborne signal with an accurate frequency may be a DSRC or 5G signal that is compatible with radio 24, and may be received by radio 24, as indicated at 32. The OBU may fix, modify or establish its own frequency, as indicated at 26, in accordance with the accurate frequency received in the signal. The OBU may then transmit precise GPS time error or compensation to GPS receiver 28, as indicated at 34. Thus, OPS receiver 28 may achieve a fast time to first fix (TTFF), as indicated at 36. The above-described process of providing GPS receiver 28 with accurate time may achieve fast TTFF of the order of seconds, such as possibly ten seconds or less.

Arrangement 10 may provide precise GPS time error or compensation to GPS receiver 28 in OBE 16 over the network by utilizing information obtained by GPS receiver 18 in RSE or Base station 14. The radio as a part of RSE 14 is able to tune its frequency to the GPS accurate frequency after GPS receiver 18 in RSE or base station 14 is able to get a fix. Each OBU in the coverage area of RSE or base station 14 may, in turn, be able to receive radio data and then retune its frequency to the accurate RSE or base station frequency. The OBU radio unit may also get frequency and time markers from GPS receiver 28 in OBE 16 and then calculate the difference in time between its own accurate time and that of GPS receiver 28. An error message or compensation value can then be fed to the digital signal processor (DSP) of GPS receiver 28 that can account for the error in the GPS search which then results in a fast TTFF, as indicated at 36.

The GPS engine in the RSU may be able to obtain accurate time once it is able to get a GPS fix. The radio chipset accept time synch pulse from the GPS chipset then may be able to adjust its own phase locked loop (PLL) to generate GPS accurate LO frequency. In turn, the radio RF frequency may be modulated by the accurate LO frequency. Then the transmitted signal from the RSU may be GPS accurate. The PLL is the circuit part where the LO frequency is generated. LO “local oscillator” is the signal that the mixer uses to convert the IQ data to RF and it controls the modulation frequency.

The reverse may happen on the OBU side. The radio may adjust by synchronizing its own frequency to that of the received signal. At this point, there are different ways to hand over the information to the GPS engine in the OBU. A first way is to provide a time synchronization pulse. A second way is to provide a direct reference to the GPS chip set. A third way is for the radio chipset to receive the reference signal from the GPS chipset and conduct a comparison with its own reference signal to determine the difference in the reference signals. The radio chipset may then communicate the difference in the reference signals back to the GPS chipset. At this point, the GPS chipset may choose to fix its timing or apply the time error to its DSP calculation. Alternatively, this same comparison may be performed in a separate chip.

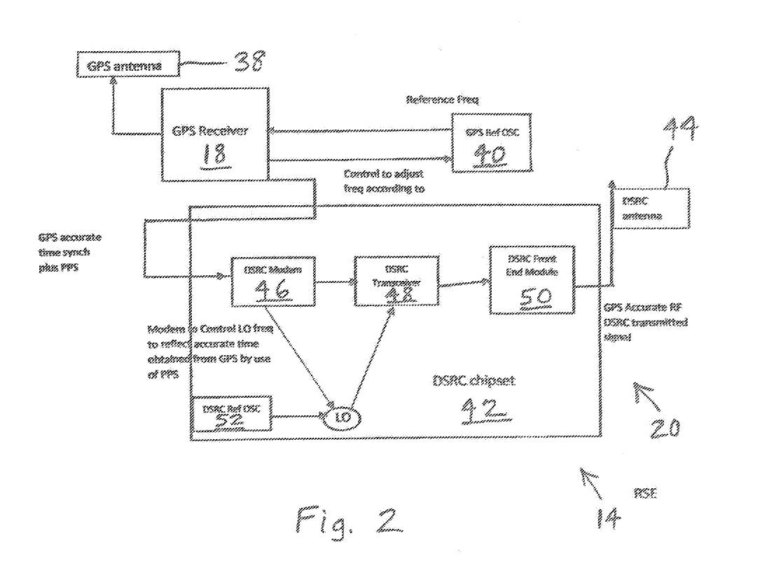

FIG. 2 illustrates one embodiment of road side equipment or base station 14, including GPS receiver 18, radio 20, a GPS antenna 38, and a GPS reference oscillator 40. GPS receiver 18 communicates bi-directionally with reference oscillator 40, thereby providing a control mechanism to adjust frequency according to a reference frequency of oscillator 40.

Radio 20 includes a radio chipset 42 and a radio antenna 44. Radio chipset 42 includes a radio modem 46, a radio transceiver 48, a radio front end module 50, and a radio reference oscillator 52. Modem 46 may control LO frequency to reflect accurate time obtained from GPS by use of a pulse-per-second signal. A similar arrangement can be applied to a 5G base station.

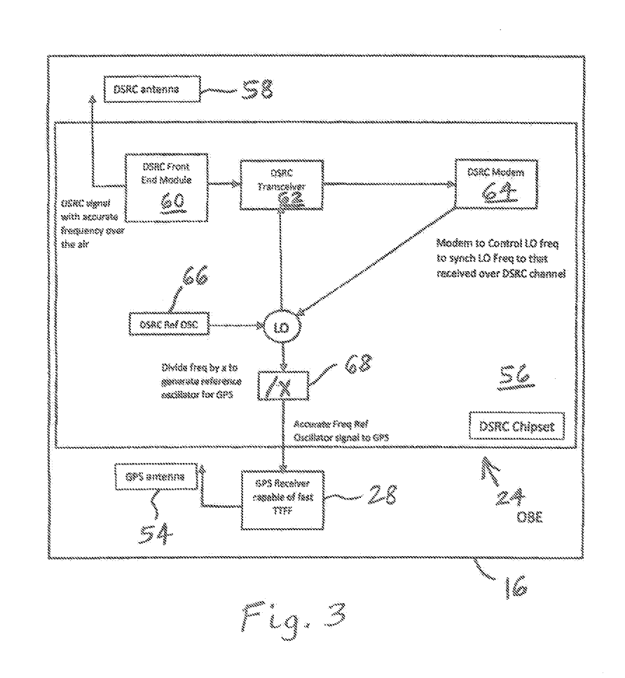

FIG. 3 illustrates one embodiment of on-board equipment 16 of arrangement 10 of FIG. 1. On-board equipment 16 includes radio 24, GPS receiver 28 and GPS antenna 54. radio 24 includes a radio chipset 56 and a radio antenna 58, radio chipset 56 includes a radio front end module 60, a radio transceiver 62, a radio modem 64, a radio reference oscillator 66 and a divider 68. Radio antenna 58 transmits an airborne radio signal with accurate frequency.

Modem 64 may control the LO frequency to synchronize the LO frequency to the frequency received over the radio channel. Divider 68 may divide the LO frequency by x to generate a reference oscillator frequency for GPS. Thus, an accurate oscillator reference frequency signal may be transmitted to GPS. A similar arrangement can be applied to a 5G unit.

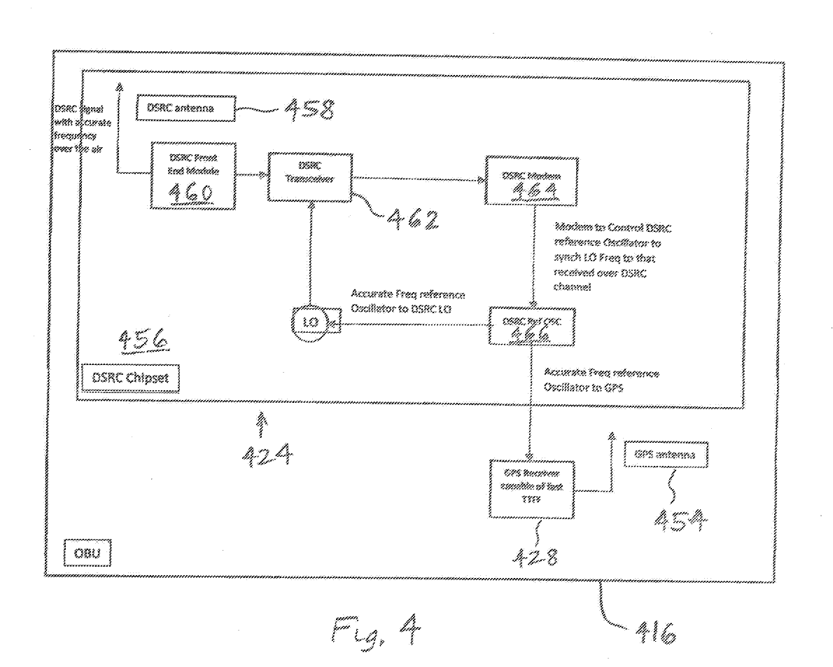

FIG. 4 illustrates another embodiment of on-board equipment 416, including a radio 424, a GPS receiver 428 and a GPS antenna 454. Radio 424 includes a radiochipset 456 and a radio antenna 458. Radio chipset 456 includes a radio front end module 460, a radio transceiver 462, a radio modem 464 and a radio reference oscillator 466. Radio antenna 458 transmits an airborne radio signal with accurate frequency.

Modem 464 may control radio reference oscillator 466 to synchronize the LO frequency to the frequency received over the radio channel. The accurate oscillator reference frequency signal may be transmitted from oscillator 466 to both GPS receiver 428 and to radio LO. A similar arrangement can be applied to a 5G network.

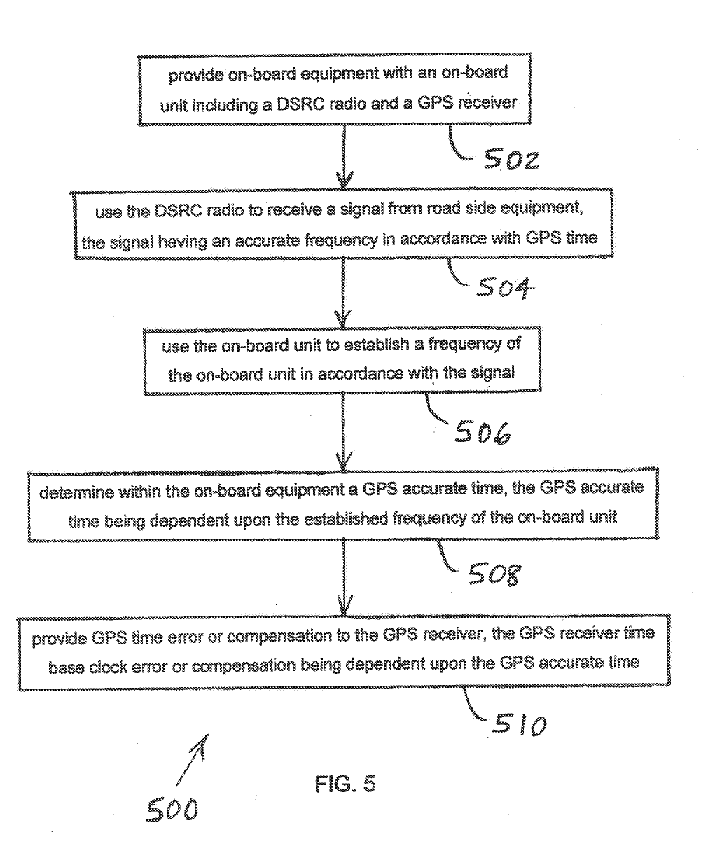

FIG. 5 is a flow chart of one embodiment of a method 500 of the present invention for operating on-board equipment in a motor vehicle. In a first step 502, the on-board equipment is provided with an on-board unit including a radio and a GPS receiver. For example, on-board equipment 16 may be provided with an on-board unit having a radio 24 and a GPS receiver 28.

Next, in step 504, the radio is used to receive a signal from road side or base station equipment. The signal has an accurate frequency in accordance with GPS time. For example, the road side equipment may transmit an accurate frequency signal 30 which may be received by radio 24, as indicated at 32.

In a next step 506, the on-board unit is used to establish a frequency of the on-board unit in accordance with the signal. For example, the on-board unit may establish its own frequency, as indicated at 26, in accordance with the accurate frequency received in the signal.

In step 508, a GPS accurate time is determined within the on-hoard equipment. The GPS accurate time is dependent upon the established frequency of the on-board unit. For example, on-board equipment 16 may determine GPS accurate time based on its own frequency in accordance with the received accurate frequency signal 30.

In a final step 510, GPS time error or compensation is provided to the GPS receiver. The GPS receiver time base clock error or compensation is dependent upon the OPS accurate time. For example, the on-board equipment may transmit precise GPS time error or compensation, which is dependent upon the OPS accurate time, to GPS receiver 28, as indicated at 34. Thus, GPS receiver 28 may achieve a fast time to first fix (TTFF), as indicated at 36.

Although DSRC radios are described herein as being included in the road side equipment and in the on-board equipment, it is to be understood that other types of radio frequency devices may be used instead of DSRC radios within the scope of the invention. For example, in all embodiments described above, each DSRC radio may be replaced by a respective C-V2X radio, and all corresponding DSRC hardware may be replaced by C-V2X hardware. Also, in all embodiments described above, each DSRC radio may be replaced by a respective 5G radio, and all corresponding DSRC hardware may be replaced by 5G hardware. Thus, more generally, all embodiments described above may be applied to any type of V2X radio communication within the scope of the invention. The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. On-board equipment for a motor vehicle, the on-board equipment comprising:
a radio configured to receive a signal from road side equipment, the signal having an accurate frequency in accordance with GPS time; and
a GPS receiver communicatively coupled to the radio, the on-board equipment being configured to determine the GPS accurate time, determine its GPS receiver time base inaccuracy and provide time base error or compensation to the GPS receiver, the determining of the GPS accurate time being dependent upon the accurate frequency in the signal, the GPS time base error or compensation being dependent upon the GPS accurate time.

2. The on-board equipment of claim 1 wherein the radio comprises a DSRC radio.

3. The on-board equipment of claim 1 wherein the radio comprises a C-V2X radio.

4. The on-board equipment of claim 1 further comprising an on-board unit including the radio, the onboard unit being configured to:
calculate a difference in time between its own accurate time and a time base of the GPS receiver;
calculate an error message or compensation value based on the calculated difference in time; and
transmit the error message or compensation value to the GPS receiver.

5. The on-board equipment of claim 1 wherein the on-board unit and GPS receiver are configured to determine the GPS accurate time in less than ten seconds.

6. The on-board equipment of claim 1 further comprising an on-board unit including the radio and the GPS receiver, the on-board unit being configured to establish the frequency of the on-board unit by synchronizing the frequency of the on-board unit with the accurate frequency of the RSE.

7. The onboard equipment of claim 6 wherein the on-board unit is configured to determine the GPS accurate time by synchronizing a time setting with the accurate frequency.

8. The on-board equipment of claim 1 wherein the GPS receiver makes use of the time error provided in its position calculation in order to achieve fast TTFF.

9. A method of operating on-board equipment in a motor vehicle, the method comprising:
providing the on-board equipment with an on-board unit including a radio and a GPS receiver;
using the radio to receive a signal from road side equipment, the signal having an accurate frequency in accordance with GPS time;
using the on-board unit to establish a frequency of the on-board unit in accordance with the signal;
determining within the on-board equipment a GPS accurate time, the GPS accurate time being dependent upon the established frequency of the on-board unit; and
providing GPS time error or compensation to the GPS receiver, the GPS receiver time base clock error or compensation being dependent upon the GPS accurate time.

10. The method of claim 9 wherein the radio comprises a DSRC radio.

11. The method of claim 9 wherein the radio comprises a C-V2X radio.

12. The method of claim 9 further comprising:
calculating a difference in time between the on-board unit's accurate time and a time of the GPS receiver clock;
calculating a time error message or compensation value based on the calculated difference in time; and
providing the time error message or compensation value to the GPS receiver.

13. The method of claim 9 wherein the GPS accurate time is determined within ten seconds.

14. The method of claim 9 wherein the signal comprises an airborne DSRC signal.

15. An arrangement for providing GPS accurate time in a motor vehicle, the arrangement comprising:
road side equipment including a road side unit, the road side unit having:
a first GPS receiver producing GPS accurate time; and
a first radio communicatively coupled to the first GPS receiver, the road side unit being configured to establish a frequency of the road side unit in accordance with the GPS accurate time, the road side equipment being configured to transmit a signal including an accurate frequency, the accurate frequency being dependent upon the first GPS receiver; and
on-board equipment, the on-board equipment comprising:
a second radio configured to receive the signal from the road side equipment; and
a second GPS receiver communicatively coupled to the second radio;
the on-board equipment being configured to:
determine the GPS accurate time, the determining of the GPS accurate time being dependent upon the accurate frequency in the signal;
ascertain GPS receiver time base error or compensation based on the GPS accurate time; and
provide the GPS receiver time base error or compensation to the second GPS receiver.

16. The vehicle of claim 15 wherein the signal comprises an airborne DSRC signal.

17. The vehicle of claim 15 wherein the first radio comprises a first DSRC radio.

18. The vehicle of claim 17 wherein the second radio comprises a second DSRC radio.

19. The vehicle of claim 15 wherein the first radio comprises a first C-V2X radio.

20. The vehicle of claim 19 wherein the second radio comprises a second C-V2X radio.
